(19) United States
(12) Patent Application Publication
(10) Pub. No.: US 2022/0060400 A1
(43) Pub. Date: Feb. 24, 2022

(54) Portable Test System for Aircraft System Installation Verification and End-to-End Testing

(71) Applicant: SMARTSKY NETWORKS LLC, Morrisville, NC (US)

(72) Inventor: David Claassen, Sterling, VA (US)

(21) Appl. No.: 17/421,066

(22) PCT Filed: Jan. 22, 2020
(86) PCT No.: PCT/US2020/014538

§ 371 Date: Jul. 7, 2021

Related U.S. Application Data
(60) Provisional application No. 62/807,304, filed on Feb. 19, 2019.
(60) Provisional application No. 62/796,113, filed on Jan. 24, 2019.

(51) Int. Cl. H04L 12/26; H04B 17/309

(52) U.S. Cl. CPC H04L 43/0811; H04B 17/309; H04L 43/50

(57) ABSTRACT

A portable test platform for testing aviation electronics connectivity to a core network includes a test controller, a test equipment cell site operating under control of the test controller, and a test antenna assembly operably coupled to the test equipment cell site and configured to provide a wireless link to an aircraft base radio of a grounded aircraft. The test equipment cell site is configured to act as a radio access network cell site within the core network.

### CROSS REFERENCE TO RELATED APPLICATION

This application claims priority to U.S. provisional application Nos. 62/796,113 filed Jan. 24, 2019 and 62/807,304 filed Feb. 19, 2019, the entire contents of which are hereby incorporated by reference in their entirety.

### TECHNICAL FIELD

Example embodiments generally relate to wireless communications and, more particularly, relate to a solution for the verification of aircraft communications systems installed on the aircraft and associated with an Air-to-Ground (ATG) network.

### BACKGROUND

High speed data communications and the devices that enable such communications have become ubiquitous in modern society. These devices make many users capable of maintaining nearly continuous connectivity to the Internet and other communication networks. Although these high speed data connections are available through telephone lines, cable modems or other such devices that have a physical wired connection, wireless connections have revolutionized our ability to stay connected without sacrificing mobility.

However, in spite of the familiarity that people have with remaining continuously connected to networks while on the ground, people generally understand that easy and/or cheap connectivity will tend to stop once an aircraft is boarded. Aviation platforms have still not become easily and cheaply connected to communication networks, at least for the passengers onboard. Attempts to stay connected in the air are typically costly and have bandwidth limitations or high latency problems. Moreover, passengers willing to deal with the expense and issues presented by aircraft communication capabilities are often limited to very specific communication modes that are supported by the rigid communication architecture provided on the aircraft.

As improvements are made to network infrastructures to enable better communications with in-flight receiving devices of various kinds, it is expected that more solutions will be put in place to try to alleviate the problems discussed above. These improvements may result in the provision of new equipment on the aircraft. In a typical situation, in order to confirm provisioning and activation of the new equipment, a test flight would need to be performed. However, doing so is very expensive, and would therefore preferably be avoided if possible.

### BRIEF SUMMARY OF SOME EXAMPLES

Some example embodiments may provide a solution that enables the first attach of communications system equipment on an aircraft to be performed via a mobile apparatus on the ground. Accordingly, confirmation of provisioning and activation and testing to confirm access to network and internet services can all be accomplished without the need of a test flight. Thus, for example, testing and network access can be performed and achieved while the aircraft is on the ground where it is not in coverage, or in suboptimal coverage of the actual ATG network in-flight.

In one example embodiment, a portable test system for testing aviation electronics connectivity to a core network is provided. The system includes a portable test platform, a user equipment (UE) test device, and an activity log. The portable test platform may be configured to provide radio access network (RAN) connectivity from an aircraft base radio (ABR) of a grounded aircraft to the core network. The UE test device may be configured to be operably coupled to the ABR to enable testing of connectivity of the UE test device to the core network. The activity log may be configured to monitor and record performance characteristics associated with the testing of connectivity.

In another example embodiment, a portable test platform for testing aviation electronics connectivity to a core network is provided. The platform includes a test controller, a test equipment cell site operating under control of the test controller, and a test antenna assembly operably coupled to the test equipment cell site and configured to provide a wireless link to an aircraft base radio of a grounded aircraft. The test equipment cell site is configured to act as a radio access network cell site within the core network.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of an ATG communication network that may benefit from employing an example embodiment;

FIG. 2 illustrates a block diagram of various components of a portable test system of an example embodiment;

FIG. 3 illustrates a more detailed block diagram of components of the portable test platform and interactions with other components of the system in accordance with an example embodiment; and

FIG. 4 illustrates a block diagram of a functional architecture of the portable test platform and UE test device according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals may be used to refer to like elements throughout. Furthermore, as used herein, the term “or” is to be interpreted as a logical operator that results in true whenever one or more of its operands are true.

As used in herein, the terms “component,” “module,” and the like are intended to include a computer-related entity, such as but not limited to hardware, firmware, or a combination of hardware and software (i.e., hardware being configured in a particular way by software being executed thereon). For example, a component or module may be, but is not limited to being, a process running on a processor, a processor (or processors), an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide strategies for improved air-to-ground (ATG) wireless communication system performance. In this regard, some example embodiments may provide improved capability for testing system components end-to-end without conducting a test flight.

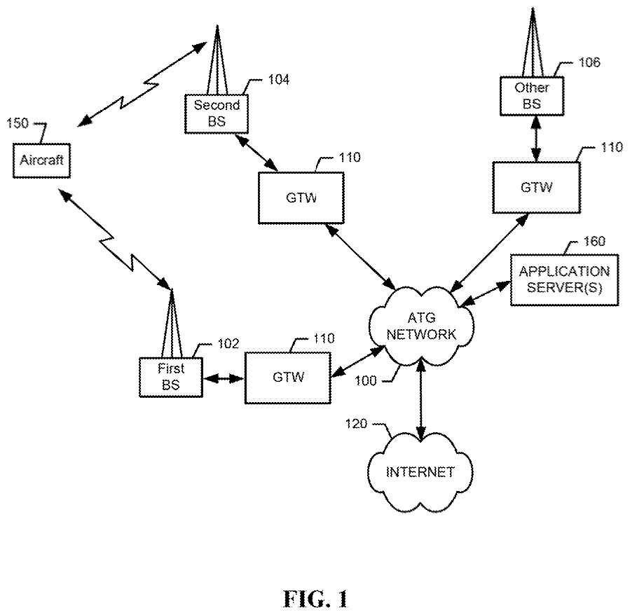

FIG. 1 illustrates a functional block diagram of an ATG network 100 that may benefit from employment of an example embodiment. As shown in FIG. 1, a first BS 102 and a second BS 104 may each be base stations of the ATG network 100. The ATG network 100 may further include other BSs 106, and each of the BSs may be in communication with the ATG network 100 via a gateway (GTW) device 110. The ATG network 100 may further be in communication with a wide area network such as the Internet 120 or other communication networks. In some embodiments, the ATG network 100 may include or otherwise be coupled to a packet-switched core network. It should also be understood that the first BS 102, the second BS 104 and any of the other BSs 106 may be either examples of base stations employing antennas configured to communicate via network frequencies and protocols defined for the ATG network 100 with an aircraft 150.

The ATG network 100 may also be referred to as a core network. In some embodiments, the core network and all of the base stations of the ATG network 100 (e.g., the first BS 102, the second BS 104 and the other BSs 106) may combine with a wired transport network (e.g., including the GTW devices 110 and other transport network components) to form a radio access network (RAN). Radio links between the RAN and communications system equipment on the aircraft 150 may facilitate the ATG communications and define the coverage area of the ATG network 100. As used herein, the term RAN refers to the deployed network providing communications (Radio Frequency) coverage to aircraft 150 while inflight.

The aircraft 150 may be in-flight and may move between coverage areas (defined in 3D space above the surface of the earth) that are associated with respective ones of the first BS 102, the second BS 104 and other BSs 106. These coverage areas may overlap such that continuous coverage can be defined and the aircraft 150 can sequentially communicate with various ones of the BSs as the aircraft 150 travels via handovers. In some cases, handovers of receivers on aircraft and/or various network control related functionalities may be accomplished under the control of a network component such as a network controller.

The network controller could be located at one (i.e., centralized) or more (i.e., distributed) locations within the ATG network 100. In some cases, the network controller or other components that are used by the network controller may be located at one or more application servers 160 that form a portion of, or are otherwise in communication with, the ATG network 100. The network controller may include, for example, switching functionality. Thus, for example, the network controller may be configured to handle routing calls to and from the aircraft 150 (or to communication equipment on the aircraft 150) and/or handle other data or communication transfers between the communication equipment on the aircraft 150 and the ATG network 100. In some embodiments, the network controller may function to provide a connection to landline trunks when the communication equipment on the aircraft 150 is involved in a call. In addition, the network controller may be configured for controlling the forwarding of messages and/or data to and from communication equipment on the aircraft 150, and may also control the forwarding of messages for the base stations. The network controller may be coupled to a data network, such as a local area network (LAN), a metropolitan area network (MAN), and/or a wide area network (WAN) (e.g., the Internet 120) and may be directly or indirectly coupled to the data network. In turn, devices such as processing elements (e.g., personal computers, laptop computers, smartphones, server computers or the like) can be coupled to the communication equipment on the aircraft 150 via the Internet 120. As such, for example, the network controller may control the core network by providing signaling and user data management and routing. The core network may therefore act as the source of provisioned data for each aircraft base radio (ABR) and, as such, authenticates activated ABRs based on secure unique ABR identifiers. The core network may also function as the ingress/egress point for all end user traffic destined to and received from network services, applications and the Internet 120.

Although not every element of every possible embodiment of the ATG network 100 is shown and described herein, it should be appreciated that the communication equipment on the aircraft 150 may be coupled to one or more of any of a number of different networks through the ATG network 100. In this regard, the network(s) can be capable of supporting communication in accordance with any one or more of a number of first-generation (1G), second-generation (2G), third-generation (3G), fourth-generation (4G), fifth-generation (5G), long term evolution (LTE) and/or future mobile communication protocols or the like. In some cases, the communication supported may employ communication links defined using unlicensed band frequencies such as 2.4 GHz or 5.8 GHz. Example embodiments may employ time division duplex (TDD), frequency division duplex (FDD), or any other suitable mechanisms for enabling two way communication (to and from the aircraft 150) within the system. Moreover, in some cases, this communication may be accomplished, and one or both of the links associated therewith may be formed, via narrow radio frequency beams that are formed or otherwise resolved by the antenna assemblies associated with the aircraft 150 and/or the base stations (102, 104, 106). As such, beamforming technology may be used to define one or both of the uplink to the aircraft 150 and the downlink from the aircraft 150.

In some embodiments, one or more instances of a beamforming control module may be employed on wireless communication equipment at either or both of the network side or the aircraft side in example embodiments. Thus, in some embodiments, the beamforming control module may be implemented in a receiving station on the aircraft 150 (e.g., a passenger device or device associated with the aircraft's communication system (e.g., a WiFi router)). In some embodiments, the beamforming control module may be implemented in the network controller or at some other network side entity. The beamforming control module may be configured to utilize location information (e.g., indicative of a relative location of the aircraft 150 from one of the base stations) to steer or form a narrow beam toward the target (e.g., the aircraft 150) from the transmitting entity (e.g., the first BS 102). The narrow beam may then reach the target (e.g., the aircraft 150) at an angle of arrival (in 3D space) determined by the relative location.

As can be appreciated from FIG. 1, for each instance of the aircraft 150, the connection of the aircraft 150 to the ATG network 100 for wireless communication purposes may include an instance of the ABR 170. The ABR 170 includes the entire ATG communications system installed in the aircraft 150. The ABR 170 includes, but is not limited to, the aircraft radio, antennas and associated electronic and power cabling. As referred to herein, the aircraft radio may include multiple measurement, processing, control and communications functions including, but not limited to: radio frequency (RF) transmission and receive, cell site selection and handover, protocol signaling and user data communications with the ground segments of the ATG network 100 (similar to a cell-phone or end-user device in a traditional wireless network). The communication function of the aircraft radio may be collectively defined as the Aircraft User Equipment or AUE. The aircraft radio may also include functions related to the measurement, logic and control required for antenna selection and antenna beam control where multiple directional antennas or antenna beam steering (electrical and/or mechanical) is deployed as a part of the aircraft side of the ATG system. The aircraft radio also provides a mechanical, electrical and communications protocol interface (or interfaces) to networking equipment on the aircraft 150 including, but not limited to wireless access points, on-board wired networks (e.g. Ethernet) and avionics networks (e.g. ARINC-429).

Provisioning, activation and authentication for new devices to a network occur as defined specifically by the network protocol being employed. Thus, for example embodiments employed in connection with wireless cellular networks, or similar networks, the processes for provisioning, activation and authentication may be similar to those defined by the Third Generation Partnership Project (3GPP) for wireless cellular networks. Within such a framework, provisioning is a process and storage systems within the core network that retains (for reference) a list of authorized unique ABR identifiers that are allowed to access network services along with the services each ABR is entitled to as well as the Quality of Service (QoS) to be provided to the ABR. A unique ABR identifier (and thus the associated ABR) is activated with the unique identifier that has been authorized for service. Authentication is the process by which the core network validates that an ABR attempting to obtain service from the network is validated. The process typically includes the establishment of a secure link between the ABR and the core network, and confirmation by the core network that the unique identifier associated with (shared by) the ABR is provisioned and activated on the network. Once authenticated, the ABR is attached to the network and may pass signaling and user data/access network services.

Referring again to FIG. 1, the ABR 170 may function similarly to traditional cellular User Equipment (UE). Thus, in operation, as the ABR 170 enters the coverage area of the ATG RAN, the ABR 170 may be configured to, based on location information (and depending upon the specific protocol implemented), identify a candidate serving cell site (e.g., first BS 102 or second BS 104) that may be available. The ABR 170 may make signal strength measures of the various available control signals from the first and second BSs 102 and 104 and may select the strongest/best cell site to which it will “attach”. Where the ABR 170 includes multiple directional antennas and/or antenna beam forming technology, this process will also include measurements of the best directional antenna and/or determination of the best possible beam angle (and formation of that beam) to assure the strongest possible radio link between the ABR 170 and the serving cell site amongst the first or second BSs 102 or 104.

Depending upon the specific protocol implementation, the “attach” procedure between the ABR 170 and the ATG network 100 may require the exchange of (typically) encrypted authentication data between the ABR 170 and the core network. In general, each ABR is uniquely identifiable by the core network by a provisioning process that occurs before the first time an ABR attaches to the network. This process includes the entry, processing and storage of a secure unique identifier for each ABR that authorizes the ABR to use the network services and may further identify specific network services and QoS available to the ABR 170, as mentioned above. During an “attach” attempt, an encrypted and secure exchange of information (protocol specific) may occur in which the ABR 170 and core network will exchange encryption information, establish a secure link, and the ABR 170 will then provide its uniquely identifying information. Upon verification of this information against the provisioning data stored within the core network (e.g., at the application server 160), the core network will then authenticate the ABR 170 and allow the ABR 170 to complete the network attach process and begin communications of user data (and other signaling data as may be associated with such network functionality as cell site hand-off and data routing).

End users (end user equipment) on the aircraft 150 may communicate with applications and services on the ground (or communicate with other aircraft) by means of the ABR 170 and ATG network 100. Direct network access for end users on the aircraft 150 may therefore be provided via the ABR 170. Access to the ABR 170 may be provided to end users on the aircraft 150 via a wireless network access point (e.g. WiFi, cabin wireless access point (CWAP), hotspot, Bluetooth, and/or the like) or wired network (e.g. Ethernet, A429, and/or the like) to which the ABR 170 is connected. The ABR 170 manipulates incoming/outgoing data according to the employed air interface protocol and passes that data (receives data from) the RAN, which in turn send/receives that data to/from the core network. The core network will then route the data to the appropriate service or application. For example, an end user on the aircraft 150 wishing to use an internet service via a laptop computer may wirelessly attach to a WiFi hotspot in the aircraft 150. The WiFi hotspot may in turn be connected via Ethernet to the ABR 170. The ABR 170 communicates that user data via the RAN to the core network, which in turn routes the end user data to the appropriate location on the Internet 120.

As discussed above, before the ABR 170 and any equipment on the aircraft 150 can operate on the ATG network 100, provisioning and activation of the ABR 170 must be accomplished. Meanwhile, the ATG network 100 is typically optimized for coverage for aircraft that are in-flight. Moreover, coverage provided by the ATG network 100 for assets on the ground is typically either non-existent, insufficient, or at least highly non-representative of the coverage that can be expected while in-flight. As such, testing and maintenance activities that assure or optimize performance while on the ground is normally highly ineffective. Specifically, during installation of communications equipment to provide ATG systems on an aircraft, there is limited or no ability to confirm that the ABR systems have been successfully installed without a “test flight”. Additionally, without the appropriate ATG network 100 coverage, there is no (or limited ability) to assure the an ABR 170 is appropriately provisioned in the core network until the aircraft 150 is flown into network coverage and the ABR 170 is either authenticated (allowed to attach because the unit is appropriately provisioned and activated) or denied access (not allowed to attach because the unit is not provisioned and activated on the network). Accordingly, the confirmation of correct/optimized installation of ATG-based ABR equipment, as well as confirmation of provisioning and activation require the “test flight” to be flown, and all of the attendant costs associated therewith to be absorbed. While generally sufficient to achieve the goal, the cost of one or more test flights can be substantial. Accordingly, it is desirable to mitigate these costs by providing an appropriate test system located on the ground that may be used in lieu of (or in advance of) flying the aircraft into ATG coverage to confirm installation and provisioning.

In order to avoid the cost and complication of performing a test flight, example embodiments introduce a portable test system that is configure to enable verification of aircraft communications systems installed on the aircraft 150 while the aircraft 150 remains on the ground. In this regard, the portable test system of example embodiments may be configured to allow full installation, validation and optimization of the ABR 170 and any components thereof while the aircraft 150 is on the ground. To accomplish this, the portable test system is configured to confirm appropriate network provisioning and activation by supporting authentication of the ABR 170 and attachment of the ABR 170 to the core network. Moreover, the portable test system may further be configured to confirm end user access to applications and services provided by the ATG network 100 and/or the Internet 120 via the ABR 170.

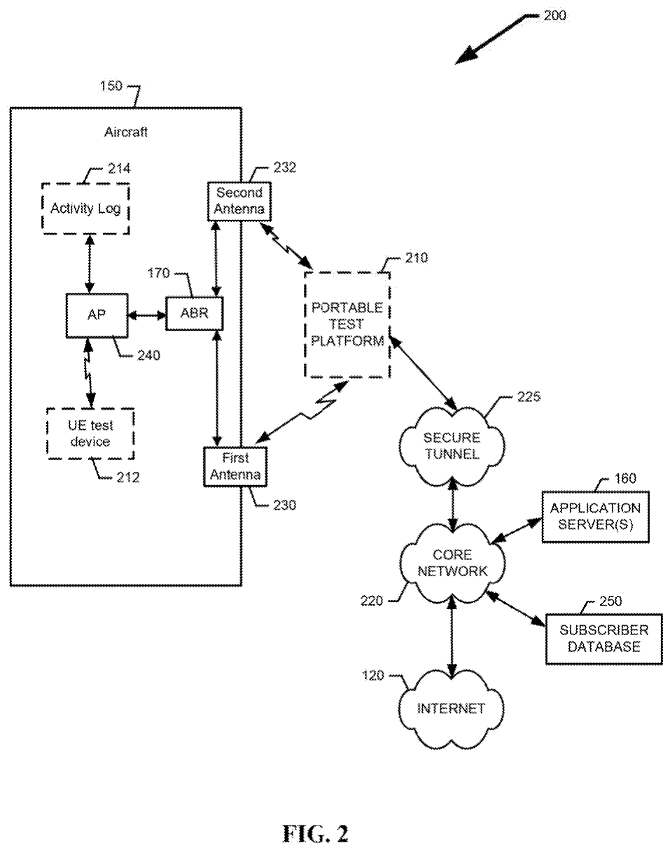

FIG. 2 illustrates a block diagram of various components of a portable test system 200 of an example embodiment. In this regard, the portable test system 200 includes a portable test platform 210. The portable test platform 210 may be a portable RAN test subsystem that includes (or otherwise can work in cooperation with) detachable pieces that can be put on the aircraft 150 to facilitate testing. These detachable pieces may include a UE test device 212 and an activity log 214. In an example embodiment, the portable test platform 210 may be embodies as a portable case or cart including all of the hardware and software associated with the portable test platform 210. For example, the portable test platform 210 could be embodied as a suit case-type housing inside which all of the components thereof may be transported. The case can either be lifted or rolled (e.g., due to wheels or another mobility assembly being operably coupled to the case). The UE test device 212 and/or the activity log 214 may be stored in the case and then removed for placement on the aircraft 150 during testing.

The portable test platform 210 may also be configured to provide a path (e.g., secure tunnel 225) for connection of the ABR 170 to core network 220 for authentication (e.g., confirming provisioning and activation) via interaction with a subscriber database 250 that includes information for initial provisioning, activation and/or attachment as described above. The path may also be used to test data routing to and from services and/or the Internet 120 by providing the ability to directly authenticate and attach the ABR 170 to the core network 220. The path provided by the portable test platform 210 also enables testing of specific end user functionality. For example, the path for connection from the ABR 170 to the core network 220 can be used to execute programmed test cases that determine whether end users have access to services, applications and the Internet 120. In this regard, the UE test device 212 may be programmed to interact with the application server 160 to confirm access to servers and/or services via the core network 220 and/or the Internet 120. Of note, the portable test platform 210 can also enable monitoring and/or operational management by a remote operator/manager as well (e.g., at a network operations center). In some cases, the portable test platform 210 may also be configured to control the functional state of the ABR 170 in order to implement specific test cases in support of testing as may be required for regulatory purposes (for example placing the ABR 170 in peak transmit power sequentially for each radio frequency channel to be employed in order to validate that they ABR does not produce Electromagnetic Interference (EMI) harmful to critical aircraft avionics).

As shown in FIG. 2, the ABR 170 may be operably coupled to a first antenna 230 and a second antenna 232. The first and second antennas 230 and 232 may be any suitable antennas (or assembly of antennas). However, in some cases, one or both of the first and second antennas 230 and 232 may be capable of employing beamforming to direct beams toward specific directions on the ground to connect to one of the BSs described in reference to FIG. 1 above. Although the first and second antennas 230 and 232 may be physically separated between front and rear portions of the aircraft 150, other placement strategies may be employed in other embodiments.

The ABR 170 may also be operably coupled to a wireless access point (AP) 240, which may in turn be operably coupled to a router. The AP 240 may be operably coupled to the UE test device 212 and the activity log 214. In this regard, the AP 240 may be operably coupled to the UE test device 212 via a wireless connection. However, in some cases, the AP 240 may be operably coupled to the activity log 214 via a temporary wired connection. In an example embodiment, both the activity log 214 and the UE test device 212 may also be operably coupled to the portable test platform 210 as well during testing. The operable coupling may be provided either by wired or wireless connection.

It should also be noted that, depending on the network protocol and other sources of network timing, some embodiments may require a GPS/timing function to further be employed by the portable test platform 210. Moreover, in some cases, the portable test platform 210 may also include a backhaul router. The backhaul router may be operably coupled to the secure link 225.

The portable test platform 210 may be configured to provide local RAN coverage (i.e., on the ground) such that the ABR 170 is able to establish a radio frequency link with the RAN while the aircraft 150 is on the ground. In some cases, the secure tunnel 225 may be a secure tunnel formed over public internet to allow the ABR 170 to ultimately connect to the core network 220. The portable test platform 210 may be programmed with test cases that may be run automatically with a graphical user interface (GUI) providing positive indication of pass/fail in order to confirm correct installation and optimization of the ABR 170 and components thereof on the aircraft 150. The test cases may include an antenna connection test that is configured to confirm that antennas (e.g., the first and second antennas 230 and 232) on the aircraft 150 are connected correctly. The test cases may also include an antenna function test that is configured to confirm that the correct antenna or antennas are selected and/or to confirm that any beam forming functionality associated with the system is properly forming beams. The test cases may also include a signal strength test that is configured to confirm that radiated signal strength from the ABR 170 is correct and within specification. These test cases may be executed in concert with the UE test device 212 where appropriate, and all activity on the aircraft 150 side may be recorded by the activity log 214.

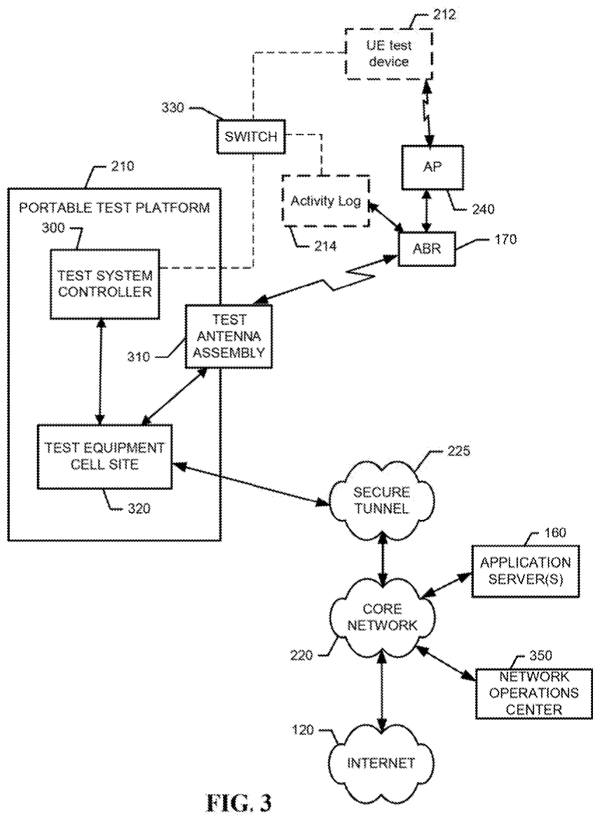

FIG. 3 illustrates a more detailed block diagram of components of the portable test platform 210 and their interaction with other components of the system 200. In this regard, the portable test platform 210 may include a test system controller 300, a test antenna assembly 310, and radio equipment defining a test equipment cell site 320. The test equipment cells site 320 may be operably coupled to the secure tunnel 225 of FIG. 2 via an Ethernet connection, a cellular connection, or any other suitable communications connection. Meanwhile, as noted above, since the test system controller 300 may be operably coupled to the activity log 214 and the UE test device 212, an Ethernet connection assembly may be formed involving an Ethernet switch 330 that enables instantiation and control over the connections between the test system controller 300 and the UE test device 212, the activity log 214 and/or the ABR 170. The switch 330 may be implemented in software within the test system controller 300 in some cases. The switch 330 and Ethernet ports may be disabled by the test system controller 330 if it is desirable to manually power on the ABR 170 and/or manually perform testing from the UE test device 212.

The test equipment cell site 320 may be a software defined cell site (e.g., a small cell) with one or more transmit/receive radio frequency channels at least including all channels employed by the RAN network. The test antenna assembly 310 may include one or more transmit and receive antennas that are narrow beam width devices such that the beam width is equal to or narrower than the beam width of the first and second antennas 230 and 232 associated with the ABR 170 and/or any formed antenna beam associated therewith. The test system controller 300 may include the GUI mentioned above in order to provide GUI driven control of all elements of the portable test system 200. The test system controller 300 may further include fully automated test scripts that configure each test component, perform each test, and provide pass/fail test results to the operator/technician. The test system controller 300 may also provide software defined test functionality including, but not limited to: signal analyzer, signal generator, Ethernet switch(es), radio frequency power meters. Thus, in some example embodiments, the test system controller 300 may be configured to provides the ability to remotely control setup, configuration and operation of the ABR 170, UE test device 212 and logging computer/memory units associated with the activity log 214.

As noted above, the UE test device 212 may be remotely attached (e.g., via wired or wireless connection) to the test system controller 300. In some cases, the UE test device 212 may, under the control of the test system controller 300, provide a GUI and scripted test cases emulating end user use of the network services and/or Internet access remotely. Alternatively, the UE test device 212 may be used independent of the test system controller 300 by the operator/technician (i.e., locally) to perform end user specific test functionality not otherwise scripted within the test system controller 300. Meanwhile, the activity log 214 may be operably coupled to the ABR 170 (e.g., via a maintenance port), and may be remotely attached (e.g., wired or wirelessly to the test system controller 300 specifically for the purposes of capturing system and other logs as may be desired or required for trouble shooting in the event a specific scripted test case does not pass. Captured logs may be captured and hand carried (e.g., via a portable memory device), remotely downloaded (e.g., via Ethernet or other connectivity) or locally access by the operator/technician.

The test system controller 300 (and therefore also the system 200) may be fully programmable with all (or nearly all) test functions implemented in software. The test system controller 300 may also be capable of running a single test script or running through a series of test scripts and corresponding tests in an automated fashion, thereby providing test setup guidance and test results via a GUI. In some embodiments, the test system controller 300 may include software defined test instruments that may be controlled, monitored and measured by the system 200 and may be configured for full validation of aircraft system installation. The test system controller 300 may also be configured to enable authentication and network access to validate (end-to-end) provisioning and provisioned service, and end user access to network services and the internet. Moreover, the test system controller 300 can be quickly modified to accommodate new test procedures.

During operation, prior to any testing, and prior to “powering up” the ABR 170, the test system controller 300 may turn on the test equipment cell site 320. The test equipment cell site 320 may be equipment that is known by the core network 220 as a deployed part of the RAN (though identified differently to account for its mobility and occasional/intermittent use (a typical RAN cell site does not move and is always “on” unless there is a fault condition)). Backhaul, from the cell site test equipment to the core network 220 may be implemented via Ethernet or wireless connection (cellular, WiFi, etc.) and from there using the public Internet as transport connectivity, as discussed above. The test system controller 300 will establish the secure tunnel 225 over the backhaul/transport connection to the core network 220. Once the test equipment cell site 320 is powered up and backhaul/transport connectivity and secure tunnel 225 is established the test system controller 300 may be configured to confirm that the test system controller 300 is fully connected to the core network 220 and that communications (as defined by the specific network protocol) are functioning correctly. The ABR 170 may then be powered up (manually or by the test system controller 300) and instructed as to which antenna port and beam to use (the test system controller 300 will have instructed the operator/technician where specifically to place the portable test equipment). At this point, the ABR 170 connects to the radio equipment of the test equipment cell site 320 and connects to and authenticates with the core network 220 as defined by the network protocol and as would occur if the aircraft 150 were in flight. Successful authentication results in the ABR 170 being attached to the core network 220 and confirms that the unit is appropriately provisioned and activated. The test system controller 300 may then confirm the success of this test case with the operator/technician via the GUI.

Once the ABR 170 is attached to the core network 220, the UE test device 212 may then run test routines to confirm connectivity to target services, the Internet 120 or test servers (e.g., the application server 160) where specific functional performance tests may be run. In addition, once fully attached to the network, a network operations center (NOC) 350 (which provides operations, administration and management) for the deployed RAN network and the installed ABRs may be able to retrieve specific identifying information from the ABR 170, validate the software version of the ABR 170 and, if necessary, update the software of the ABR 170 to the correct version. The NOC 350 can fully monitor the ABR 170 as a network attached device including detection of any performance alarms and monitoring of key performance indicators. By monitoring the core network 220, the NOC 350 is also able to validate that the provisioned network services and QoS is provided/accessible to the ABR 170.

The test equipment cell site 320 (as may be implemented as a software defined radio (SDR)) is controlled by the test system controller 300. The test equipment cell site 320 may be embodied as a miniature/portable version of a full macro-cell site as implemented in the RAN and can generate and receive the appropriate air interface waveform and protocol such that it appears to the ABR 170 as any RAN cell site (e.g., the first and second BSs 102 and 104). The test system controller 300 may also control the ABR 170 and UE test device 212. The test system controller 300 therefore includes all the programming and scripts required to run a full suite of necessary tests or may run an individual test depending on the operator/technician's requirements. The test system controller 300 will also provide information to the operator/technician if manual set up procedures are required. For example, when confirming the correct installation of a particular antenna, the test system controller 300 may inform the operator/technician to physically move or place the test equipment cell site 320 at a certain location with respect to the aircraft 150 and/or the antennas of the ABR 170. Thus, for example, the operator/technician may receive specific instructions including an angle to form from the antenna with respect to the nose of the aircraft and distance from the aircraft antenna.

For any specific test the test system controller 300 may configure the ABR 170 (via the ABR maintenance port) and test equipment cell site 320 to perform the required function. The test system controller 300 may instruct the ABR 170 to transmit on a specific channel frequency and on a specific antenna and/or antenna beam. Simultaneously the test system controller 300 may instruct the test equipment cell site 320 to receive ABR transmissions/radio frequency energy on the required channel frequency. The test system controller 300 may then implement a software defined network analyzer or RF power meter to measure the emissions from the antenna. The test system controller 300 may then determine the measured performance against the expected performance specification and notify the operator/technician of test passing or failure. In the event of a failed test the test system controller 300 may, via the GUI, request that the operator/technician confirm any required manual steps were performed correctly. ABR logs and Key Performance Indicators (KPIs) can be captured on the activity log 214 for download and analysis. Similarly, cell site logs may be captured by the test system controller 300 for download and review to assist in fault root cause analysis. The set of tests (performance and antenna installation tests) may be performed sequentially for each antenna and/or beam requiring the operator/technician to move the portable test platform 300 as required to be within the beam width of the selected antenna and/or beam.

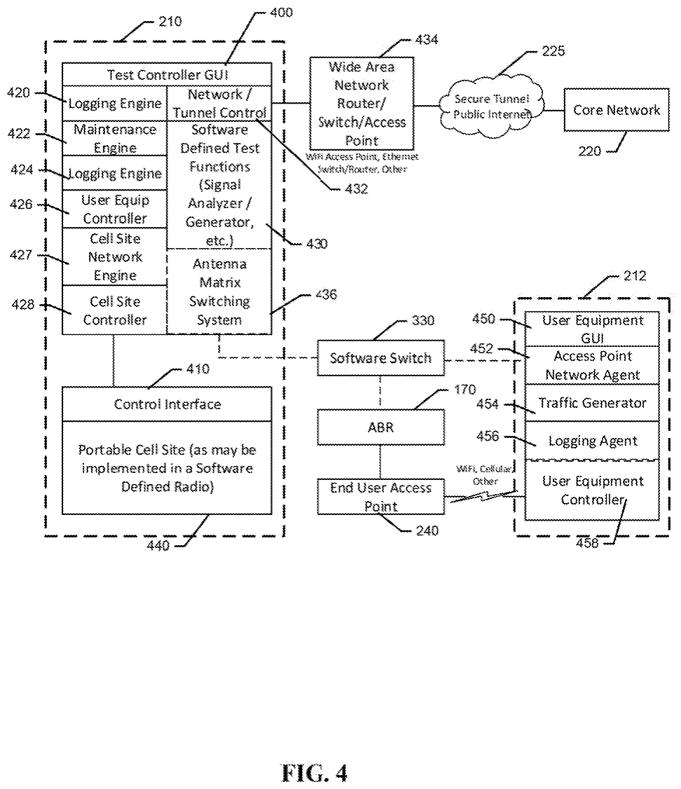

FIG. 4 illustrates a block diagram of a functional architecture of the portable test platform 300 and the UE test device 212 according to an example embodiment. The architectures of each may be powered by processing circuitry that may be configured to perform data processing, control function execution and/or other processing and management services according to an example embodiment of the present invention. In some embodiments, the processing circuitry may be embodied as a chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry may include one or more instances of a processor and memory. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of an on-board computer or processor.

The processor may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In an exemplary embodiment, the memory may include one or more non-transitory memory devices such as, for example, volatile and/or non-volatile memory that may be either fixed or removable. The memory may be configured to store information, data, applications, instructions or the like for enabling the processing circuitry to carry out various functions in accordance with exemplary embodiments of the present invention. For example, the memory could be configured to buffer input data for processing by the processor. Additionally or alternatively, the memory could be configured to store instructions for execution by the processor. As yet another alternative, the memory may include one or more databases that may store a variety of data sets responsive to input sensors and components. Among the contents of the memory, applications and/or instructions may be stored for execution by the processor in order to carry out the functionality associated with each respective application/instruction.

In an example embodiment, the processing circuitry of the portable test platform 210 may be embodied as, include or otherwise control the operation of the components of FIG. 4 that are associated with the portable test platform 210. Meanwhile, the processing circuitry of the UE test device 212 may be embodied as, include or otherwise control the operation of the components of FIG. 4 that are associated with the UE test device 212.

As shown in FIG. 4, the processing circuitry of the portable test platform 210 may operate to control a test controller GUI 400 and/or a control interface 410. The test controller GUI 400 may interface with various functional elements that may also be controlled by the processing circuitry including a logging engine 420 (for logging local activity), a maintenance engine 422, a logging engine 424 (for logging remote activity), a user equipment controller 426 (e.g., for interfacing with the UE test device 212, a cell site network engine 427 for managing activities of the test equipment cell site 320, and a cell site controller 428. The test controller GUI may also include an interface element 430 for software defined test functions such as signal analysis/generation functions. The test controller GUI 400 may also functionally enable interfacing between the portable test platform 210 and the secure tunnel 225 via a network/tunnel control element 432 that may interface with a WAN router, switch or access point 434 that may be a part of or operably coupled to the portable test platform 210. The test controller GUI 400 may also functionally enable interfacing between the portable test platform 210 and the switch 330 via an antenna matrix switching system 436. The control interface 410 may include a portable cell site element 440 that may be implemented in a software defined radio.

As shown in FIG. 4, the processing circuitry of the UE test device 212 may include a user equipment GUI (UE GUI) 450. The UE GUI 450 may functionally control an access point network agent 452 that operably couples to the switch 330. The UE GUI 450 may also include a traffic generator 454, a logging agent 456 and a UE controller 458 to facilitate each respective function on the UE test device 212.

In accordance with an example embodiment, a portable test system for testing aviation electronics connectivity to a core network is provided. The system includes a portable test platform, a user equipment (UE) test device, and an activity log. The portable test platform may be configured to provide radio access network (RAN) connectivity from an aircraft base radio (ABR) of a grounded aircraft to the core network. The UE test device may be configured to be operably coupled to the ABR to enable testing of connectivity of the UE test device to the core network. The activity log may be configured to monitor and record performance characteristics associated with the testing of connectivity.

In some embodiments, the system (and corresponding components thereof) may be configured to include additional features, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the portable test platform may include a test system controller that is configured to execute pre-programmed test scenarios to conduct the testing of connectivity. In an example embodiment, the test system controller may be configured to execute pre-programmed test cases to conduct the testing of connectivity. In some cases, the test cases may include an antenna connection test configured to confirm that antennas on the aircraft are connected correctly, a signal strength test configured to confirm that radiated signal strength from the ABR is within specification, or an antenna function test. The antenna function test may be configured to confirm correct antenna selection among antennas on the aircraft or confirm beam forming functionality associated with antennas on the aircraft is properly forming beams. In an example embodiment, the test system controller may be configured to automatically run the pre-programmed test scenarios and output a pass/fail indication to an operator via a graphical user interface at the portable test platform. In some cases, the test system controller may be configured to interface with the UE test device to execute at least one scenario involving the UE test device accessing internet resources. In an example embodiment, all activity of the ABR and the UE test device may be recorded by the activity log. In some cases, the test system controller may provide instructions to an operator regarding manual set up procedures. In an example embodiment, providing instructions to the operator may include instructing the operator regarding an angle to form with respect to antennas of the aircraft to test individual beams of the antennas. In some cases, the portable test platform may be configured to enable the ARB to conduct a first attachment to the core network while on the aircraft is on the ground. In an example embodiment, the portable test platform may be configured to confirm the ARB is provisioned and authenticated in the core network while the aircraft is one the ground.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A portable test system for testing aviation electronics connectivity to a core network, the system comprising:
a portable test platform configured to provide radio access network (RAN) connectivity from an aircraft base radio (ABR) of a grounded aircraft to the core network;
a user equipment (UE) test device configured to be operably coupled to the ABR to enable testing of connectivity of the UE test device to the core network; and
an activity log configured to monitor and record performance characteristics associated with the testing of connectivity.

2. The system of claim 1, wherein the portable test platform comprises a test system controller, and
wherein the test system controller is configured to execute pre-programmed test scenarios to conduct the testing of connectivity.

3. The system of claim 2, wherein the test system controller is configured to execute pre-programmed test cases to conduct the testing of connectivity.

4. The system of claim 3, wherein the test cases include an antenna connection test configured to confirm that antennas on the aircraft are connected correctly.

5. The system of claim 3, wherein the test cases include a signal strength test configured to confirm that radiated signal strength from the ABR is within specification.

6. The system of claim 3, wherein the test cases include an antenna function test configured to confirm correct antenna selection among antennas on the aircraft.

7. They system of claim 3, wherein the test cases include an antenna function test configured to confirm beam forming functionality associated with antennas on the aircraft is properly forming beams.

8. The system of claim 2, wherein the test system controller is configured to automatically run the pre-programmed test scenarios and output a pass/fail indication to an operator via a graphical user interface at the portable test platform.

9. The system of claim 2, wherein the test system controller is configured to interface with the UE test device to execute at least one scenario involving the UE test device accessing internet resources.

10. The system of claim 9, wherein all activity of the ABR and the UE test device is recorded by the activity log.

11. The system of claim 2, wherein the test system controller provides instructions to an operator regarding manual set up procedures.

12. The system of claim 11, wherein providing instructions to the operator includes instructing the operator regarding an angle to form with respect to antennas of the aircraft to test individual beams of the antennas.

13. The system of claim 1, wherein the portable test platform is configured to enable the ARB to conduct a first attachment to the core network while on the aircraft is on the ground.

14. The system of claim 13, wherein the portable test platform is configured to confirm the ARB is provisioned and authenticated in the core network while the aircraft is one the ground.

15. A portable test platform for testing aviation electronics connectivity to a core network, the platform comprising:
a test controller;
a test equipment cell site operating under control of the test controller, the test equipment cell site being configured to act as a radio access network (RAN) cell site within the core network; and
a test antenna assembly operably coupled to the test equipment cell site and configured to provide a wireless link to an aircraft base radio (ABR) of a grounded aircraft.

16. The platform of claim 15, wherein the test system controller is configured to execute pre-programmed test cases to conduct the testing of connectivity.

17. The platform of claim 15, wherein the portable test platform is configured to enable the ARB to conduct a first attachment to the core network while on the aircraft is on the ground.

18. The platform of claim 17, wherein the portable test platform is configured to confirm the ARB is provisioned and authenticated in the core network while the aircraft is one the ground.

19. The platform of claim 15, wherein the test cases include:
an antenna connection test configured to confirm that antennas on the aircraft are connected correctly;
a signal strength test configured to confirm that radiated signal strength from the ABR is within specification; and
an antenna function test.

20. The platform of claim 19, wherein the antenna function test configured to confirm correct antenna selection among antennas on the aircraft or confirm beam forming functionality associated with antennas on the aircraft is properly forming beams.
